(19) United States
(12) Patent Application Publication
(10) Pub. No.: US 2004/0194864 A1
(43) Pub. Date: Oct. 7, 2004

(54) Pneumatic tire

(76) Inventor: Tsutomu Saeki, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/477,715

(22) PCT Filed: May 15, 2002
(86) PCT No.: PCT/JP02/04715

(30) Foreign Application Priority Data
May 15, 2001 (JP) 2001-144294

(51) Int. Cl. B60C 15/00; B60C 15/06

(52) U.S. Cl. 152/539; 152/541; 152/552

(57) ABSTRACT

There is provided a pneumatic tire capable of effectively preventing the pulling-out of a side portion of a carcass ply, in which the side portion of the carcass ply is wound around a bead core and a pulling-out restraint member of the carcass ply is arranged between the winding portion and the bead core to support a tensile force applied to a main body portion of the carcass ply with the pulling-out restraint member.

### TECHNICAL FIELD

This invention relates to a pneumatic tire, particularly, a heavy duty pneumatic radial tire, and more particularly proposes a technique that a resistance to pull-out of a carcass ply is improved in a structure of a bead portion wherein a side portion of the carcass ply is wound around a bead core embedded in the respective bead portions and substantially along a profile line of the bead core at a cross-section thereof.

### BACKGROUND ART

In the heavy duty pneumatic radial tire, at least one carcass ply is toroidally extended from a tread portion through a sidewall portion to a bead portion, and a side portion of the carcass ply is fixed by winding around a bead core embedded in the respective bead portion from an inside toward an outside in a radial direction of the tire. In this case, it is common to make a turnup height of the side portion of the carcass ply sufficiently high for preventing the pulling-out of the ply cords during the running of the tire under loading.

In such a bead portion structure, however, a step difference in rigidity is caused between the inner side and the outer side bordering a radially outer end position of the turnup portion of the carcass ply in the radial direction of the tire, so that stress concentrates in the radially outer end and in the vicinity thereof through repetitive flexible deformation and circumferentially shear deformation from the bead portion to the sidewall portion during the running of the tire under loading, and hence it is easy to cause separation failure of the outer end from the rubber portion. As a result, there is caused a problem that the above separation failure progresses toward, for example, both inside and outside surfaces of the bead portion to cause the bead portion crack.

Also, the similar problem is caused on the basis that fine cracks resulted from picking of the end of the ply cord to the rubber portion facing the cord end grow during the running of the tire under loading.

In order to solve such problems, it is recently proposed that as shown by a cross section of the bead portion in FIG. 1, a large protrusion of a side portion 102 of a carcass ply 101 outward from a bead core 103 in the radial direction of the tire is removed by winding the side portion 102 along a circumferential face of a bead core 103 having, for example, a hexagonal shape in cross section and therearound in stead of winding to a higher position with respect to the bead core 103 outward in the radial direction of the tire, whereby the separation failure of the turnup end of the carcass ply from a rubber portion can be prevented to improve the durability of the bead portion 104.

In this proposed technique, however, the side portion 102 of the carcass ply 101 is wound around the bead core 103 through relatively soft coating rubber layers therefor, and when a large tensile force is particularly applied to a main body portion of the carcass ply extending between the bead cores, for example, under an action of a load to the tire, these coating rubber layers can not exert a sufficient resistance to pulling-out on the carcass ply and hence ply cords thereof, so that there is a problem that the uncertainty of the carcass ply 101 over the pulling-out still remains.

It is, therefore, an object of the invention to solve the above problems and to provide a pneumatic tire in which the fear of pulling-out the carcass ply is sufficiently removed while sufficiently preventing the occurrence of the bead portion crack resulted from the highly winding-up of the side portion of the carcass ply outward in the radial direction of the tire.

### DISCLOSURE OF THE INVENTION

The pneumatic tire according to the invention comprises a pair of bead portions each including a bead core and a carcass ply extending between the bead cores and winding its side portion around the respective bead core, characterized in that a pulling-out restraint layer for the carcass ply is arranged between the bead core and a winding portion of the carcass ply.

In this tire, the occurrence of the crack in the bead portion can sufficiently be prevented by winding the side portion of the carcass ply around the bead core, for example, along a cross-sectional profile line thereof in stead of winding to a higher position outward in the radial direction of the tire, while the pulling-out of the carcass ply can effectively be prevented by arranging the pulling-out restraint layer for the carcass ply between the bead core and the winding portion of the carcass ply, which is different from coating rubbers for the bead core and the carcass ply, to sufficiently support tensile force acting to the main body portion of the carcass ply with the pulling-out restraint layer to thereby reduce strain generated between the bead core and the turnup portion.

It is preferable that the pulling-out restraint layer is constituted by a rubber composition. Also, the rubber composition is preferable to have a JIS A hardness of 20-90, more preferably 40-60.

The term “JIS A hardness” used herein means a numeric value as measured at a test temperature of 20° C. by using a durometer hardness test machine of type A defined by JIS K 6253-1993.

According to the former case of using the rubber composition as the pulling-out restraint layer, the function of reducing the strain with respect to the repeated input can be developed over a long period of time, while according to the latter case, the rubber composition can develop a proper restraining force against the pulling-out. That is, when Shore A hardness is less than 20, the rubber composition is difficult to develop a function for supporting the sufficient tensile force or a function for reducing the strain, while when it exceeds 90, there is a fear that the pulling-out restraint layer itself is broken relatively prematurely.

And also, it is preferable that a distance from a winding end of the carcass ply to a surface of the bead core opposite thereto is not less than 0.3 mm but not more than 7 mm, particularly not less than 0.3 mm but not more than 4 mm.

This is due to the fact that when the pulling-out restraint layer between the winding end and the bead core is too thin, it is difficult to develop a sufficient strain reducing function due to the separation failure or the like of the pulling-out restraint layer, while when it is too thick, it is difficult to exert a sufficient restraining force on the carcass ply with the bead core.

Therefore, when the distance from the whole of the winding portion of the carcass ply to the surface of the bead core is made within a range of 0.3-7 mm, the pulling-out of the carcass ply can more effectively be prevented.

Furthermore, it is preferable that the winding portion of the carcass ply is provided with one or more bending parts directing to a direction wound around the bead core.

In this case, the carcass ply can be wound so as to further approach to the peripheral face of the bead core, and hence the winding shape thereof can be approximated to an expected shape.

Even in all cases, it is preferable that a distance of radius from a center of the tire to the winding end of the carcass ply is not more than a distance of radius in a position located at an outermost side in the whole winding portion of the carcass ply in the radial direction of the tire.

In addition, when a neighboring portion to the winding end of the carcass ply is extended at an approximately constant distance with respect to the surface of the bead core opposite thereto in the cross section of the bead portion, the pulling-out restraint layer results in existing at substantially a uniform thickness between the neighboring portion to the winding end and the surface of the bead core, so that the whole of the neighboring portion to the winding end can be equally restrained by the pulling-out restraint layer to largely enhance the total restraining force against the pulling-out.

Moreover, the term “neighboring portion to the winding end” used herein means a portion extending outward from an inner peripheral edge or an inner peripheral face of the bead core in the radial direction of the tire at a posture of tire inflated under an internal pressure after rim-assembling.

It is more preferable that a distance from the winding end of the carcass ply to a main body portion of the carcass ply extending between the bead cores is not less than 0.1 mm but not more than 5 mm.

That is, when the distance is less than 0.1 mm, the stress concentrates in the winding end on the occasion of the fall-down deformation of the sidewall portion of the tire under the application of a heavy load to the tire, and there is a fear of generating the separation failure and the cracks, while when it exceeds 5 mm, there is a fear that the pulling-out restraint layer can not sufficiently develop the function of the layer itself.

In the invention, when the winding portion of the carcass ply is provided with one or more bending parts located approximately in correspondence to corner parts of the bead core having corner parts in its cross section, the restraining force of the carcass ply by the bead core can be more further enhanced.

### BRIEF DESCRIPTION OF THE DRAWINGS

FIG. 1 is a cross-sectional view of a bead portion in the conventionally proposed technique with respect to a winding structure of a carcass ply.

FIG. 2 is a cross-sectional view showing an embodiment according to the invention likewise FIG. 1.

FIG. 3 is an enlarged section view of a main part of FIG. 1.

FIG. 4 is an enlarged section view of a main part showing another embodiment of the invention.

### BEST MODE FOR CARRYING OUT THE INVENTION

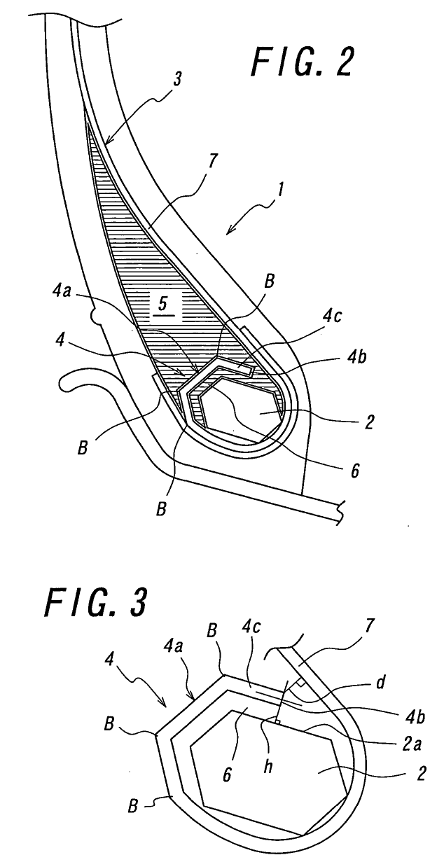

In FIG. 2 showing an embodiment of the invention at a posture of applying an air pressure to a tire assembled on a rim, numeral 1 is a bead portion and numeral 2 is a bead core embedded in the bead portion 1.

In this figure, a cross section shape of a bead core 2 having a ring shape as a whole is hexagonal. With respect to the bead core 2, a side portion of a carcass ply 3 as a skeleton reinforcing layer is wound along substantially a profile line of the cross section of the bead core 2 from an inside of the bead portion 1. A pulling-out restraint layer or a rubber composition 6 constituting a part of a stiffener 5 in the figure is arranged between a neighboring portion 4a to a winding end of a winding portion 4, that is, a portion extending outward from an inner peripheral face of the hexagonal bead core 2 in the radial direction in the figure and a surface of the bead core.

In this case, it is preferable that the winding portion 4 is provided with one or more bending parts directing in a direction wound around the bead core 2, three bending parts B in the figure for the purpose of performing the winding so as to approach the winding portion 4 to the surface of the bead core. Moreover, when the bead core 2 has corner parts as shown in the figure, it is preferable to arrange the bending parts B in correspondence to the corner parts. Also, when the bead core 2 has a polygonal profile shape, the winding portion 4 is preferable to be extended straight between the bending parts and at a free end part located from the leading-end bending part toward a top side, respectively.

Even in all cases, it is preferable that at least the neighboring portion 4a to the winding end is extended at substantially a constant distance with respect to the surface of the bead core opposite thereto, for example, substantially in parallel thereto to make the thickness of the rubber composition 6 interposed between the neighboring portion and the bead core substantially uniform for the purpose of enhancing the total restraining force of the rubber composition 6 against the pulling-out of the carcass ply 3.

Moreover, it is preferable that the hardness of the rubber composition 6 is made 20-90 as JIS A hardness for the purpose of developing a proper restraining force against the pulling-out.

As shown by an enlarged section view of a main portion in FIG. 3, it is more preferable that a distance h from a winding end 4b of the carcass ply 3 to a surface of the bead core opposite thereto is not less than 0.3 mm but not more than 7 mm. And also, it is preferable that a distance from the winding end 4b to a main body portion 7 of the carcass ply extending between the bead cores is not less than 0.1 mm but not more than 5 mm, particularly not less than 0.3 mm but not more than 4 mm.

In addition, with respect to a free end part 4c located from the leading-end bending part B toward a top side in the illustrated embodiment, considering rectangular coordinates in which a normal line drawn through the winding end 4b to the surface of the bead core is an ordinate and a straight line segment perpendicular to the ordinate through the winding end 4b is an abscissa, an angle of the free end part 4c with respect to the abscissa is 0°.

In such rectangular coordinates, when the abscissa is standard and a state of extending the free end part 4c at an upper side of the abscissa, that is, in a first quadrant or a second quadrant is positive and a state of extending at a lower side of the abscissa, that is, in a third quadrant or a forth quadrant is negative, an inclination angle of the free end part 4c with respect to the abscissa is preferable to be within a range of −15° to +60°.

In this case, the free end part 4c frequently approaches to the surface of the bead core toward the winding end, so that the restraining force to the carcass ply through the bead core can be gradually enhanced toward the top end and hence the resistance to the pulling-out can be enhanced.

When the inclination angle of the free end part exceeds 60°, the top end of the free end part 4c steeply approaches to the surface of the bead core, and also the thickness of the pulling-out restraint layer 6 interposed between the free end part and the bead core surface 2a steeply changes, and hence strain amount of the pulling-out restraint layer itself resulted from the tensile force in the pull-out direction applied to the carcass ply 3 largely changes in the extending direction of the free end part 4c, so that there is a fear that premature separation from at least one of the bead core surface 2a and the free end part 4c, shear breakage of the pulling-out restraint layer itself and the like are particularly caused in a thinnest portion of the pulling-out restraint layer 6 by the repeated tensile forces applied to the carcass ply 3. While, when it is less than −15°, the free end part itself is too far from the bead core and hence it is difficult to sufficiently restrain the winding portion of the carcass ply through the bead core.

According to the tire having the above construction, the rubber composition 6 can sufficiently support the tensile force applied to the main body 7 of the carcass ply as previously mentioned, so that the pulling-out of the carcass ply can be effectively prevented.

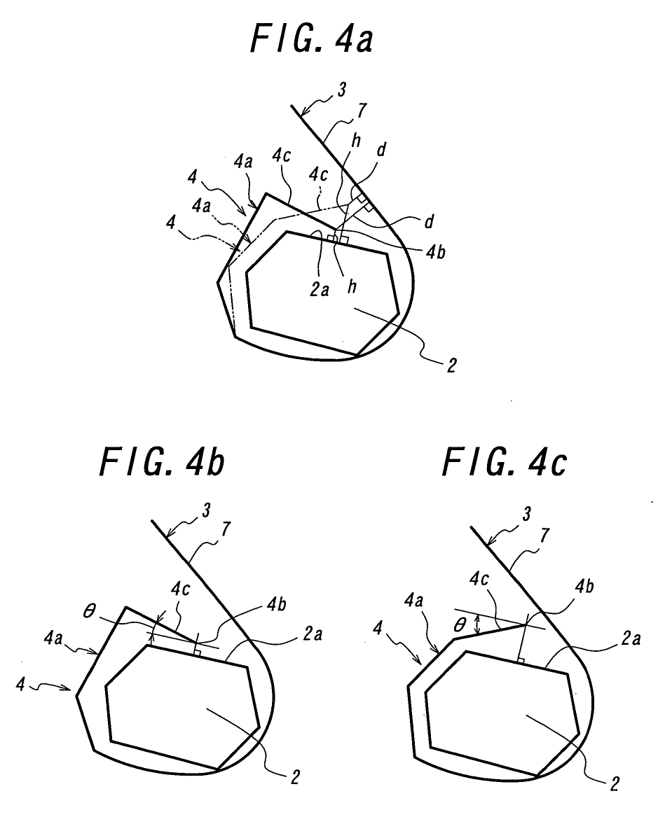

FIG. 4 is an enlarged section view of a main portion showing another two embodiments according to the invention, in which a case shown by a solid line is that the neighboring portion 4a to the winding end of the winding portion 4, in especial, the free end part 4c located from the leading-end bending part B toward the top end side is particularly extended so as to straightly approach toward the winding end 4b with respect to the bead core surface 2a opposite thereto.

On the other hand, in a case shown by a phantom line of the figure, the similar free end part 4c is extended so as to straightly separate toward the winding end 4b with respect to the bead core surface opposite thereto.

Even in these winding embodiments, a distance h from the winding end 4b to the bead core surface opposite thereto is preferable to be within a range of 0.3-7 mm, and a distance d from the winding end 4b to the main body portion 7 of the carcass ply is preferable to be within a range of 0.1-5 mm.

And also, it is preferable even in both cases that the inclination angle of the free end part 4c with respect to the bead core surface opposite thereto, that is, the inclination angle θ as measured on the basis of an abscissa in rectangular coordinates in which a normal line drawn through the winding end 4b to the bead core surface 2a is an ordinate and a straight line segment perpendicular to the ordinate through the winding end 4c is an abscissa as shown in FIGS. 4b and 4c is within a range of −15° to 60°.

Even in these embodiments, therefore, the action and effects similar to those of FIG. 2 can be obtained by interposing the rubber composition 6 constituting a part of the stiffener between the bead core 2 and the winding portion 4 of the carcass ply 3, particularly the neighboring portion 4a to the winding end.

Although the embodiments of the invention are described based on the drawings, the winding portion of the carcass ply may take a structure omitting the illustrated free end part located from the leading-end bending part toward the top end side. In this case, a portion extending outward from the inner peripheral edge or the inner peripheral face of the bead core in the radial direction of the tire becomes the neighboring portion to the winding end, so that by arranging the pulling-out restraint layer between this portion and the bead core surface can be obtained the action and the effects similar to those mentioned above. Moreover, the bead core surface opposite thereto in this case is a surface adjacent to an outer surface side of the tire with respect to the surface 2a shown in the figure.

And also, the cross sectional shape of the bead core may be polygonal shapes such as a quadrangle, a pentagon or the like other than shapes shown in the figures in addition to a circular shape, a oval shape or the like.

Furthermore, although the rubber composition constituting a part of the stiffener is arranged between the bead core and the carcass ply in the illustrated embodiment, it may be made of a rubber completely different from the stiffener. Alternatively, it is possible to arrange an organic fiber woven cloth, a cord layer comprised of steel cords having a diameter of not more than 1 mm, a laminate made of thermosetting resin films, a plastic such as FRP or the like in stead of the rubber composition.

### EXAMPLES

### Example 1

Example tires 1 and 2 has a tire size of 315/60 R22.5 and comprise a bead portion having a winding structure shown in FIG. 2, in which the neighboring portion 4a to the winding end is extended at substantially a constant distance from the bead core surface, and the winding end 4b is positioned at a widthwise central portion of the bead core surface 2a and the distance therefrom to the main body portion of the carcass ply is 4 mm, and the thickness of the rubber composition located between the neighboring portion 4a and the bead core surface 2a and having a JIS A hardness of 60 is 5 mm and 6.3 mm, respectively, and Example tires 3 and 4 comprise a bead portion in which a winding embodiment of the winding portion is changed as shown in FIGS. 4b and 4c, respectively. Each of these tires is run at 60 km/h on a drum for a durability test under a maximum air pressure of 850 kPa and a load of 117.6 kN to measure a running distance until the tire brings about troubles.

And also, strain in the pulling-out direction at section of the winding end of the carcass ply is measured by a CT scan in the stop of the tire and further strain in the circumferential direction is measured from strain at the outside of the side portion.

These results are shown in Table 1.

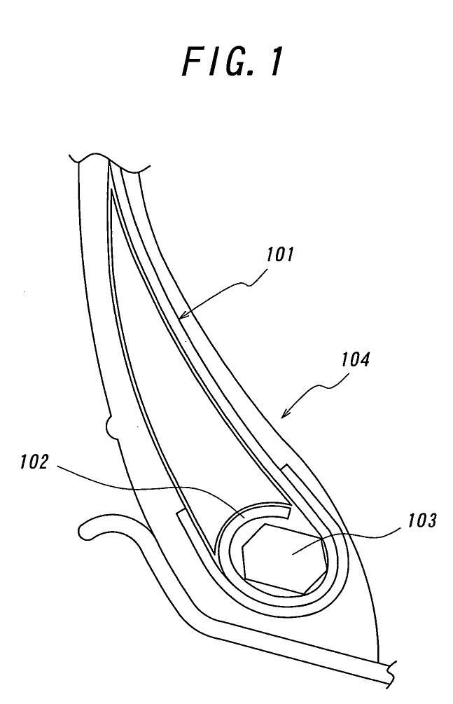

Moreover, the conventional tire shown in the table has a bead portion structure shown in FIG. 1.

Also, numerical values in the table are represented by an index on the basis that the conventional tire is a control wherein the larger the measured value, the larger the index value.

TABLE 1

| | | | | | Strain in | |
|---|---|---|---|---|---|---|
| | Thickness | Inclination | | Strain in | circumferential | Running |
| | in rubber | angle of free | Reinforcement | section | direction | distance |
| | composition | end part | of bead portion | (Index) | (Index) | (Index) |
| Conventional | | | W + 2N | 100 | 100 | 100.0 |
| tire | | | | | | |
| Example | 5 mm | 0° | W + 2N | 98 | 104 | 101.0 |
| tire 1 | | | | | | |
| Example | 6.3 mm | 0° | W | 97 | 106 | 100.0 |
| tire 2 | | | | | | |
| Example | | −15° | W | 99 | 100 | 101.0 |
| tire 3 | | | | | | |
| Example | | +15° | W | 98 | 104 | 100.5 |
| tire 4 | | | | | | |

W . . . wire chafer
N . . . nylon chafer

According to the above table, it could be confirmed in the example tires that since the winding end of the carcass ply is located close to the bead core, the strain in the circumferential direction tends to be increased, but the strain in the pulling-out direction at section is advantageously decreased by the restraining force against the pulling-out under the action of the rubber composition constituting a part of the stiffener.

As a result of these facts, the running distance and hence the durability can sufficiently be ensured.

### Example 2

Each of Example tires and Comparative tires is a tire having the structure of the aforementioned Example tire 1 as a basic structure and a distance of the winding end of the carcass ply to the bead core surface of 5 mm and a JIS A hardness of the rubber composition as a parameter, respectively, and the running distance, the strain in section and the strain in the circumferential direction thereof are measured in the same manner as mentioned above to obtain the results shown in Table 2.

In this case, the conventional tire in Example 1 is a control in which the larger the measured value, the larger the index value.

TABLE 2

| | | | Strain in | |
|---|---|---|---|---|
| | | Strain in | circumferential | Running |
| | | section | direction | distance |
| | JIS A hardness | (Index) | (Index) | (Index) |
| Comparative | 15 | 124 | 123 | 59 |
| example tire 1 | | | | |
| Comparative | 92 | 82 | 81 | 72 |
| example tire 2 | | | | |
| Example tire 5 | 40 | 104 | 106 | 100 |
| Example tire 6 | 60 | 98 | 104 | 101 |
| Example tire 7 | 80 | 90 | 89 | 100 |

As seen from Table 2, as the hardness of the rubber composition rises, the strain becomes smaller, but the fracture resistance of the rubber composition lowers and hence the running durability lowers.

### Example 3

Each of Example tires and Comparative tires is a tire having the structure of the above Example tire 1 as a basic structure and a JIS A hardness of the rubber composition of 60 and a distance of the winding end of the carcass ply to the bead core surface as a parameter, respectively, and the same measurements as in Example 1 are carried out to obtain the results shown in Table 3.

In this case, they are also evaluated by an index on the basis that the aforementioned conventional tire is a control likewise the aforementioned case.

TABLE 3

| | | | Strain in | |
|---|---|---|---|---|
| | Distance to | Strain in | circumferential | Running |
| | bead | section | direction | distance |
| | core surface | (Index) | (Index) | (Index) |
| Comparative | 9.0 mm | 106 | 107 | 90 |
| example tire 3 | | | | |
| Comparative | 0.1 mm | 101 | 93 | 99 |
| example tire 4 | | | | |
| Example tire 8 | 1.0 mm | 99 | 98 | 102 |
| Example tire 9 | 3.0 mm | 96 | 101 | 104 |
| Example tire 10 | 5.0 mm | 98 | 104 | 101 |
| Example tire 11 | 0.3 mm | 100 | 97 | 101 |

As seen from Table 3, when the distance to the bead core surface is about 0.1-6.0 mm, an excellent running durability can be ensured, and particularly the running durability becomes larger in the vicinity of 3.0 mm.

### Example 4

Each of Example tires and Comparative tires is a tire having the structure of the above Example tire 1 as a basic structure, a distance of the winding end of the carcass ply to the bead core surface of 5 mm and a JIS A hardness of the rubber composition of 60 and a distance from the winding end of the carcass ply to the main body of the carcass ply as a parameter, respectively, and the same tests as mentioned above are carried out to obtain the results shown in Table 4.

TABLE 4

| | | | Strain in | |
|---|---|---|---|---|
| | Distance to | Strain in | circumferential | Running |
| | main | section | direction | distance |
| | body portion | (Index) | (Index) | (Index) |
| Comparative | 0.08 mm | 102 | 99 | 98 |
| example tire 5 | | | | |
| Comparative | 6 mm | 105 | 105 | 97 |
| example tire 6 | | | | |
| Example tire 12 | 0.3 mm | 99 | 100 | 101 |
| Example tire 13 | 2 mm | 95 | 102 | 102 |
| Example tire 14 | 4 mm | 98 | 104 | 101 |

According to the above table, the strain in section is decreased as the distance to the main body of the carcass ply becomes short.

### INDUSTRIAL APPLICABILITY

As seen from the above, in the pneumatic tire according to the invention, when the side portion of the carcass ply is particularly wound around the bead core, the pulling-out restraint layer of the carcass ply, which may be made of the rubber composition, is arranged between the winding portion and the bead core, whereby the occurrence of the bead portion crack resulted from the winding of the side portion of the carcass ply to a higher position outward in the radial direction of the tire can be prevented but also the tensile force applied to the main body portion of the carcass ply can sufficiently be supported by the pulling-out restraint layer, and hence the pulling-out of the carcass ply can effectively be prevented.

1. A pneumatic tire comprising a pair of bead portions each including a bead core and a carcass ply extending between the bead cores and winding its side portion around the respective bead core, characterized in that a pulling-out restraint layer for the carcass ply is arranged between the bead core and a winding portion of the carcass ply.

2. A pneumatic tire according to claim 1, wherein the pulling-out restraint layer is constituted by a rubber composition.

3. A pneumatic tire according to claim 2, wherein the rubber composition has a JIS A hardness of 20-90.

4. A pneumatic tire according to claim 1, wherein a distance from a winding end of the carcass ply to a surface of the bead core opposite thereto is not less than 0.3 mm but not more than 7 mm.

5. A pneumatic tire according to claim 1, wherein the winding portion of the carcass ply is provided with one or more bending parts directing to a direction wound around the bead core.

6. A pneumatic tire according to claim 1, wherein a distance of radius from a center of the tire to the winding end of the carcass ply is not more than a distance of radius in a position located at an outermost side in the whole winding portion of the carcass ply in the radial direction of the tire.

7. A pneumatic tire according to claim 1, wherein a neighboring portion to the winding end of the carcass ply is extended at an approximately constant distance with respect to the surface of the bead core opposite thereto in the cross section of the bead portion.

8. A pneumatic tire according to claim 1, wherein a distance from the winding end of the carcass ply to a main body portion of the carcass ply extending between the bead cores is not less than 0.1 mm but not more than 5 mm.

9. A pneumatic tire according to claim 4, wherein the winding portion of the carcass ply is provided with one or more bending parts located approximately in correspondence to corner parts of the bead core having corner parts in its cross section.
